(19) United States
(12) Patent Application Publication
(10) Pub. No.: US 2018/0072072 A1
(43) Pub. Date: Mar. 15, 2018

(54) DEVICE FOR TREATING PACKAGES, AND HOLDING-AND-CENTERING UNIT FOR PACKAGES

(71) Applicant: KHS GmbH, Dortmund (DE)

(72) Inventors: Markus Reiniger, Monchengladbach (DE); Martin Schach, Bochum (DE); Holger Stenner, Haltern am See (DE)

(21) Appl. No.: 15/817,641

(22) Filed: Nov. 20, 2017

Related U.S. Application Data
(63) Continuation of application No. 14/342,436, filed on Mar. 3, 2014, now Pat. No. 9,821,569.

(30) Foreign Application Priority Data
Sep. 2, 2011 (DE) 10 2011 112 106.8
Sep. 2, 2011 (DE) 10 2011 112 281.1

(51) Int. Cl. B41J 3/407; B41J 3/54; B41J 11/00; B65B 31/04

(52) U.S. Cl. CPC B41J 3/4073; B65B 31/04; B41J 11/002; B41J 3/543

(57) ABSTRACT

An apparatus includes pucks and holding positions. Each puck has a primary part and a reconfigurable secondary part, as a result of which the secondary part is adaptable for processing packages that have different package-formats. When the puck holds a package, the first holding position holds the primary part and the secondary part is mounted to be in contact with the primary part so as to rotate when drive about an axis. A functional element handles the package while the first holding-position holds the primary part.

### RELATED APPLICATIONS

Under 35 USC 120, this application is a continuation of U.S. application Ser. No. 14/342,436, which was filed on Mar. 3, 2014, and which is the national stage entry under 35 USC 371 of PCT/EP2012/002929, filed on Jul. 12, 2012, which claims the benefit at the Sep. 2, 2011 priority dates of German applications DE 102011112281.1 and DE 102011112106.8, the contents of which are herein incorporated by reference in their entirety.

### FIELD OF INVENTION

The invention is directed to an apparatus for treating packages, and in particular, to printing on packages.

### BACKGROUND

It is often useful to place information on the container so that the consumer knows what he is buying. This information can be pre-printed on a label that is then attached to the container by a labeling machine. Another approach is to print on the container.

Known devices for printing on a container include ink-jet printers. In such devices, a holding apparatus holds the container and turns it in front of an ink-jet printer.

It is often more efficient to have successive printers, each of which prints one color. Containers are then transported from one printer to the next until all colors have been printed. This requires a transport mechanism that holds the container in front of the print head in such a way that all the colors ultimately align to form a clean image.

### SUMMARY

An object of the invention is a device that adapts easily to packages of different type, size, and form with high operational-reliability, or that can be realized with low assembly effort and in a compact design with high operational-reliability.

In one aspect, the invention features an apparatus including pucks and holding positions. Each puck has a primary part and a reconfigurable secondary part. The reconfigurable secondary part is thus adaptable for processing packages that have different package-formats. When the first puck holds a package, the first holding-position holds the primary part. The secondary part is mounted to be in contact with the primary part so as to rotate about a vertical axis of the first puck when driven and receives a functional element that is configured for at least one of holding, centering, aligning, moving, rotating, and pivoting the package while the first holding-position holds the primary part.

Some embodiments include a package transport-path on which packages are moved from a package inlet to a package outlet in a transport direction. The holding positions, each of which is configured to hold a puck, are disposed along the package transport path. The holding positions are on a module that is driven to rotate about a vertical machine axis thereof.

Other embodiments include an array of permanent magnets and either a solenoid array or a stator that interacts with the array of permanent magnets for either controlled package alignment or controlled package rotation.

Yet other embodiments include an electromagnetic direct drive configured to cause controlled handling of a package.

Also among the embodiments are those that include a servomotor housed by the primary part and a mounting-and-base part. The secondary part has a gripper that has the mounting-and-base part. This mounting-and-base part makes the secondary part configurable.

Also among the embodiments are those in which the puck includes a ring and a sleeve mounted to the ring to rotate relative to the ring.

Further embodiments include those in which a secondary part having a lower length that projects beyond an underside of the primary part and those in which the secondary part includes a sleeve and a carrier plate that is disposed at a lower open end of the sleeve.

Yet other embodiments feature a printing segment. In these embodiments, the primary part passively applies a holding force to holds the puck at the printing segment. After a package held by the first puck has been printed upon, the first puck is actively removed from the printing segment.

Other embodiments include a sensor configured to detect a rotation angle based on a structure on the primary part. The structure is configured to define a rotational angle of the primary part relative to a holding position.

Yet other embodiments include a plurality of transport-and-treatment elements adjacent to one another for transporting packages. Each of the transport-and-treatment elements includes a vertical axis about which at least some of the holding positions rotate, wherein the transport-and-treatment elements define a package transport path that extends between a package inlet and a package outlet, and wherein the first holding position is one of a plurality of holding positions along a first one of the transport-and-treatment elements.

Some embodiments include a first mounting-and-base part. In these embodiments, the secondary part is reconfigured by interchanging the first mounting-and-base part with a second mounting-and-base part, with the first and second mounting-and-base parts being adapted to a different package-formats.

In other embodiments, the, first puck picks up a package at a package inlet and moves, with the package, from the package inlet to a package outlet along a package transport path. Upon arriving at the package outlet, the first puck releases the package. The puck then traverses a puck transport path to return from the package outlet back to the package inlet.

In some embodiments, each puck includes a recess configured to cover the package in a region of a mouth thereof.

In other embodiments, each of the holding positions includes a receptacle to receive the first puck as the first puck traverse a puck transport-path that passes through multiple transport-and-treatment elements and that extends between a package inlet and a package outlet.

Some embodiments also include transport-and-treatment modules that define a transport path along which the first puck carries a package between an inlet and an outlet. Each transport-and-treatment module has a vertical machine-axis. Each holding position includes a holder that engages a puck. Each such holder is adjustable in a direction along a machine axis of whichever transport-and-treatment module at which the holder is located at.

In some embodiments, each holding position includes an inkjet print head that is adjustable along a line having an inclination relative to a machine axis.

Other embodiments have transport-and-treatment elements adjacent to each other to define a path along which the first puck moves from an inlet to an outlet. At least one of these is connectable to a source of pressure medium and also has a coupling element. The first puck has a quick-acting coupling for coupling to the source of the pressure medium. This permits containers to be pressurized. Among these are embodiments in which the puck has a non-return valve that couples via the coupling element to the source.

Other embodiments include, at each holding position, a mechanism for controlled holding and releasing of pucks.

In yet other embodiments, the secondary part has an RFID tag.

Also among the embodiments are those in which each holding position includes an inkjet print-head and a radiation source as well as those in which each holding position includes an inkjet print-head that is adjustable along a machine axis.

In addition, the invention includes embodiments in which each secondary part includes a centering-and-holding element that is configured for passively holding a package with a spring force.

As used herein, “packages” are packaging elements or containers that are usual in the food industry and specifically also in the drinks sector, including, in particular, containers such as, for example bottles, cans, and soft packages, for example those produced from cardboard and/or plastic film and/or metal film.

As used herein, the term “puck,” is understood to mean a holding, centering, and, aligning part on which a package element is held and moved from the package inlet to the package outlet through a packaging element transport path of the transport system and that preferably also provides a controlled orientation of the respective package for the latter's handling.

As used herein, “transport elements adjacent to one another for transport purposes” in the sense of the invention means transport elements or transport-and-treatment elements that are configured and arranged in such a way that, at transfer regions, they receive the pucks from an adjacent transport element that is ahead in a transport direction, hold them, and pass them to a transport element that is behind in a transport direction.

As used herein, the expressions “essentially,” “in essence,” or “around” mean variations from the respective exact value by +/−10%, preferably by. +/−5% and/or variations in the form of changes insignificant for the function.

Further embodiments, advantages and possible applications of the invention arise out of the following description of embodiments and out of the figures. All of the described and/or pictorially represented attributes whether alone or in any desired combination are fundamentally the subject matter of the invention independently of their synopsis in the claims or a retroactive application thereof. The content of the claims is also made an integral part of the description.

In particular, a holding-and-centering unit is disclosed and claimed in which the secondary part, in which the packaging element, the bottle or the container is held is mounted on or in a primary part and can be rotated and driven about a vertical axis, and can also be driven by a motor. In one embodiment, the secondary part forms the rotor of an electromagnetic direct drive, and for the controlled aligning and/or rotating of the packaging element to be effected in this way. To achieve this function, the secondary part is provided with a permanent magnet array that interacts with a stator of the electromagnetic direct rotary drive or with a solenoid array that forms the stator.

Alternatively, the secondary part may also comprise an infinitely controllable electric motor, in particular a servomotor. In this case, the primary part comprises the motor housing or consists essentially of the motor housing of an infinitely controllable motor.

Because the rotor or packaging element must be at any time in an angular position, at least one code for the rotational angle position is ideally provided on the secondary part, and, if necessary, also on the primary part. The code interacts with a suitable sensor or reading unit, in particular, one or a plurality of incremental sensors at the respective working position. Moreover, alternatively, or additionally, the primary part can always be uniquely defined or definably executed in its rotational angle position relative to the respective handling positions by a form-fitting mounting, centering unit, or a coupling element provided such that only the relative rotational angle position of the secondary part to the primary part need be configured to be detectable by a sensor, reading unit etc. The position relative to the printing segment or print head can then be derived from this.

During the printing of empty packages, especially PET, PEN, PE, or PP empty bottles, which represent the normal case, the packaging element should preferably be under a slight positive pressure. For this purpose, there is provided on the holding-and-centering unit a locking or mating piece for a coupling element on the machine or printing segment that is configured in the manner of a quick-acting coupling. With this, a vaporous or gaseous medium, e.g. compressed air, can be fed into the packaging element through an inner line, in this case the hollow interior space of the puck. The lower outlet of this inner line forms a central centering element/taper. For this, at least one transport and handling unit, ideally the first, is connected to a vapor or gas source or comprises a suitable compressor.

The locking element of the coupling is advantageously configured as a non return valve. Alternatively, a non-return valve is provided in the inner line. In this way, after the preloading to a preload pressure with a vaporous and/or gaseous medium, e.g. compressed air, this preload pressure can be maintained in the packaging element over the entire packaging element transport or pressure section in this way.

### BRIEF DESCRIPTION OF THE DRAWINGS

The invention is explained in detail below through the use of embodiment examples with reference to the figures. In the figures:

FIG. 1 shows a device that handles packages and that applies, to each package a furnishing in the form of a printed image formed from multiple printing events;

FIG. 2 shows a plan view of the device in FIG. 1;

FIG. 3 shows a serpentine conveyor path traversed by the packages as they make their way through the device shown in FIGS. 1 and 2;

FIG. 4 shows a perspective partial view of one of the transport-and-treatment elements, which showing a plurality of printing segments;

FIG. 5 shows a printing segment of the transport-and-treatment element of FIG. 4;

FIGS. 6-8 show, in different representations, a holding-and-centering unit of the device of FIG. 1, also together with a packaging element configured as a bottle;

FIG. 9 shows a section through a holding-and-centering unit of the device of FIG. 8;

FIG. 10 shows, in positions a) and b,) the holding-and-centering unit and a bottle at different times during operation;

FIG. 11 shows, in position (a), in perspective representation, a primary part of a holding-and-centering unit and in positions (b)-(g) different secondary units that can be combined with the premier part of a holding-and-centering unit;

FIG. 12 shows, in perspective representation, a transport-and-treatment element of a further embodiment of the invention, preferably for use with the device or installation of FIG. 1;

FIGS. 13 and 14 show different views of a printing segment of the transport-and-treatment element of FIG. 12;

FIG. 15 shows a simplified horizontal section through the printing segment of FIG. 13 and 14;

FIG. 16 shows a simplified vertical section through the printing segment of FIGS. 13 and 14; and

FIGS. 17 and 18 each show, in perspective partial view, a dummy segment for use with the device or installation of FIG. 1 or with the transport-and-treatment element of FIG. 12.

### DETAILED DESCRIPTION

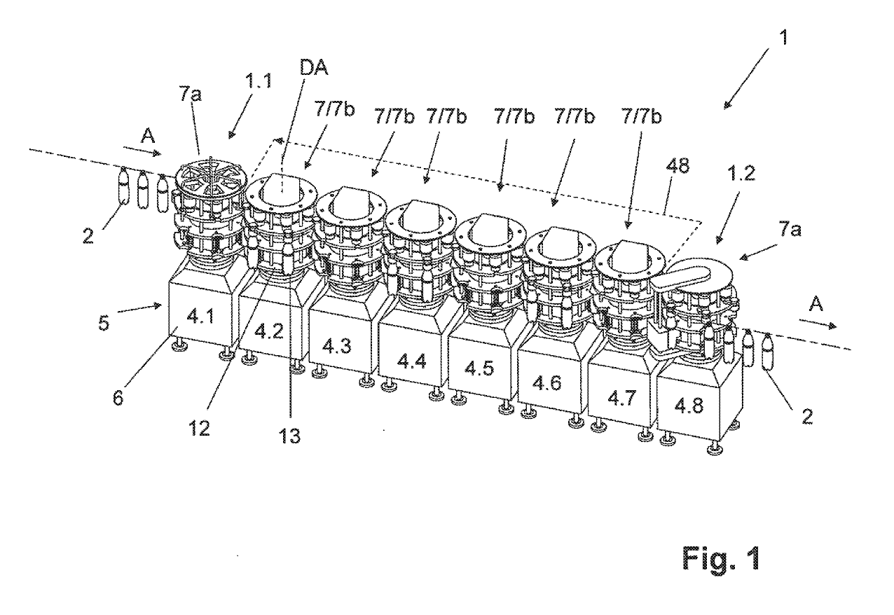

FIG. 1 shows a device 1 that prints a printed image on packages. In some embodiments, the packages 2 are bottles. The device 1 applies the printed image either directly to the exterior of a package 2 or to labels that have already been affixed to the packages.

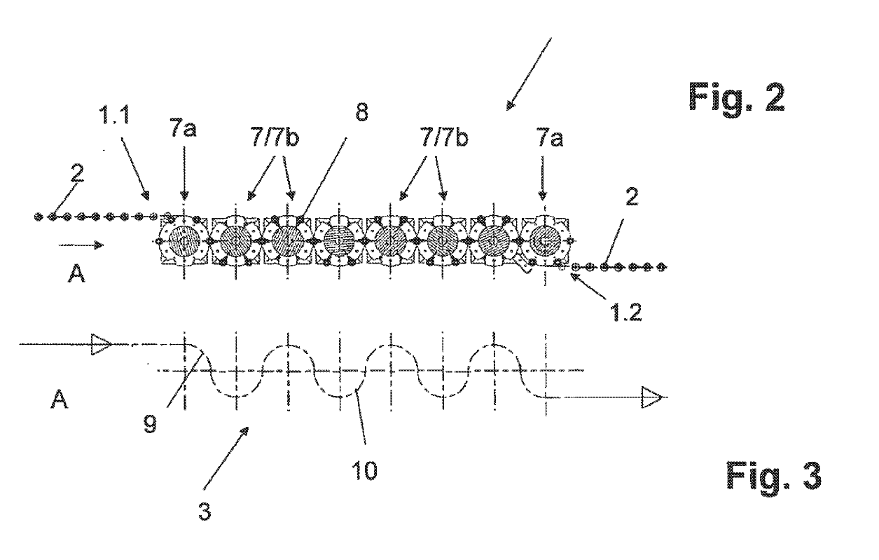

An external transporter transports upright packages 2 that are to be printed upon in a transport direction A towards the device 1 or to its package inlet. The packages 2 move within the device 1 along a serpentine transport path 3 made of multiple arcs, as shown in FIGS. 2 and 3. After having been printed upon, the packages 2, still standing upright, reach a package outlet 1.2. An outer transporter then takes the packages away.

Referring now to FIG. 1, the device 1 comprises modules 4.1-4.n that are arranged one after the other in the transport direction A. In the depicted embodiment, there are eight such modules 4.1-4.8, all of which are formed from an identical base unit 5 that has been equipped with the functional elements necessary for the special task of each module 4.1-4.8.

Each base unit 5 comprises a housing 6 that accommodates a drive-and-control unit. Arranged on the top of the housing 6 is a transport-and-treatment element 7, 7a. A particular base unit's drive-and-control unit drives its transport-and-treatment element 7, 7a to rotate about its module's vertical machine-axis.

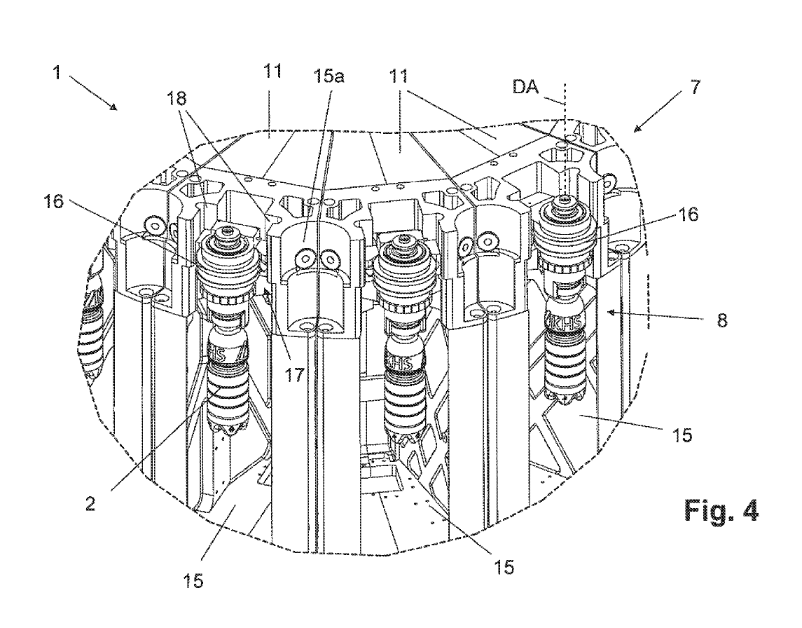

As shown in FIG. 2, and in more detail in FIG. 4, each transport-and-treatment element 7, 7a has holders 8 distributed at equal angular distances around a periphery thereof. Each holder 8 is configured to reliably pick up one package 2.

Transport-and-treatment elements 7, 7a of individual modules 4.1-8.1 are adjacent to one another and driven to rotate synchronously but in alternating directions. This causes them to collectively form a transport device that moves packages 2 within the device 1 along the serpentine transport path 3, shown in FIG. 3, between a package inlet 1.1 and a package outlet 1.2, as shown in FIG. 2 In operation, a transport-and-treatment element 7 of one module transfers a package directly to a transport-and-treatment element 7 of a successive module 4.2-4.8 that follows in a transport direction A.

In FIGS. 1 and 2, the transport-and-treatment element 7 of the first module 4.1, which is the first one along the transport direction A, is driven synchronously clockwise; the transport-and-treatment element 7 of the succeeding module, namely the second module 4.2, is driven counter clockwise; the transport-and-treatment element of the next-following module, namely the third module 4.3, is driven clockwise; and so forth. A suitable controller synchronizes the individual modules 4.1-4.8.

In the embodiment shown in the figures, individual modules 4.1-4.8 are again provided sequentially such that the vertical machine-axes of all modules 4.1-4.8 lie in a common vertical plane. Also located in this plane are the transfer regions. It is at these transfer regions that a package 2 transfers from a transport-and-treatment element 7a, 7 of one module 4.1-4.7 to a transport-and-treatment element 7, 7a of the next module 4.2-4.8 that follows in the transport direction A.

The first module 4.1 constitutes the inlet module or package inlet 1.1 of the device 1.

In some embodiments, the first module 4.1 pretreats packages 2, at least in the region of the packaging element that is to be printed upon. Examples of pretreatment include plasma or corona treatment. This treatment is practical if the application of the multiple-pass printing in the subsequent modules is effected with the use of print stations or print heads in those modules and that operate according to the known inkjet print head principle or “Tonejet” principle.

In other embodiments, the first module 4.1 pressurizes the package 2.

Second through fifth modules 4.2-4.5 following the first module 4.1 constitute the actual print modules that cause the image to be printed. Preferably, the image is a multicolor image one color being printed at each of the modules 4.2-4.5. The four modules 4.2-4.5 thus correspond to the four primary subtractive colors in a printer: yellow, magenta, cyan and black. The holders 8 in the second through fifth modules 4.2-4.5 are therefore at printing positions.

A sixth module 4.6, which then follows in transport direction A, is configured as a drying module in which the previously generated multiple-pass print is finally dried in a suitable manner. Embodiments include those that dry by applying energy, such as heat energy and/or by UV radiation.

The seventh module 4.7 is an inspection module through which each package 2 passes after the printed image has been dried. The seventh module 4.7 examines the packages for errors, identifies incorrectly printed packages 2, and separates them from the correctly printed packages. The separation can occur at the seventh module 4.7 itself or subsequently on the onward transport path.

Finally, the eighth module 4.8 constitutes an outlet module at the package outlet 1.1 of the device 1. It is through here that the fully printed packages 2 leave the device 1. Preferably, the eighth module 4.8 is configured as a drying module.

As FIG. 3 shows, packages 2 are each moved with transport-and-treatment elements 7 of the first and eighth modules 4.1, 4.8 over an angular range of approximately 90° about a vertical machine axis MA of the first and eighth modules 4.1, 4.8. In the case of the second through seventh modules 4.2-4.7, packages 2 are each entrained by respective transport-and-treatment element 7 over an angular range of 180° about the vertical machine axis of modules 4.2-4.7. The process that is assigned to the respective module is carried out in modules 4.2-4.7, within this angular range or within this path of the rotational motion of respective transport-and-treatment element 7.

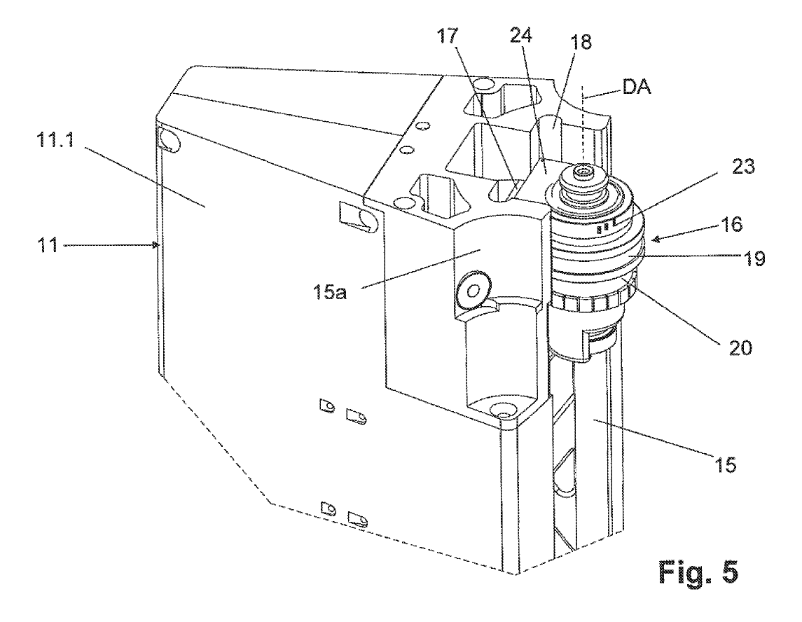

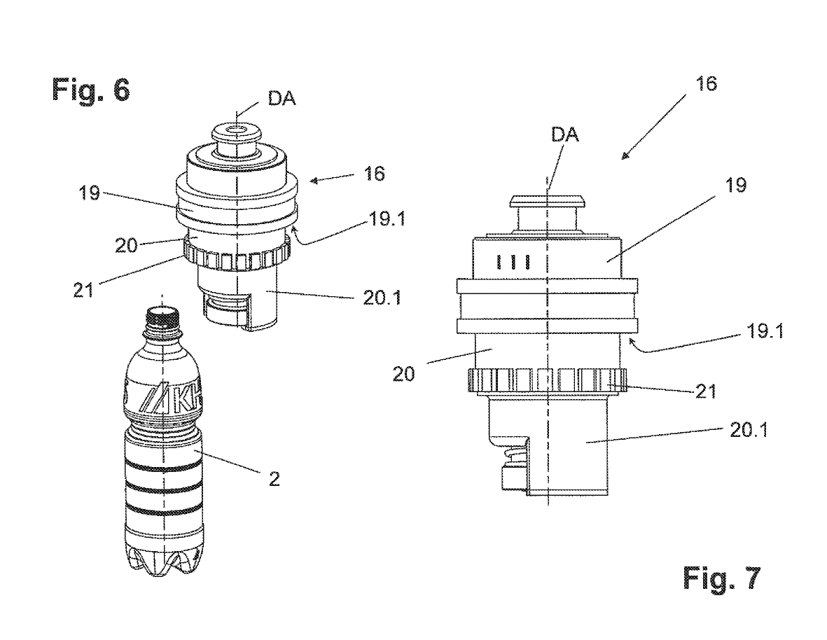

In greater detail, the modules 4.1-4.n, but at least the printing modules 4.2-4.7, which are used for the printing of packages 2, or the circulating transport-and-treatment elements 7 of these modules, include printing segments 11, as shown in FIG. 4. FIG. 5 shows one of the printing segments 11 after having been removed from a transport-and-treatment element 7.

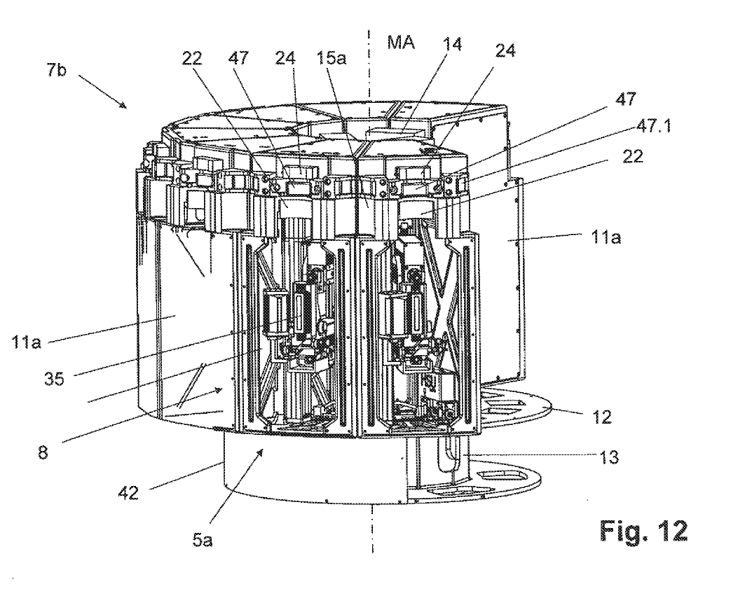

These printing segments 11 are each mounted interchangeably as complete functional assembly units on a rotor 12, which can be seen in FIG. 12. The rotor 12 is mounted so as to rotate about the vertical machine axis MA on the module housing 6 or on a central pillar 13.

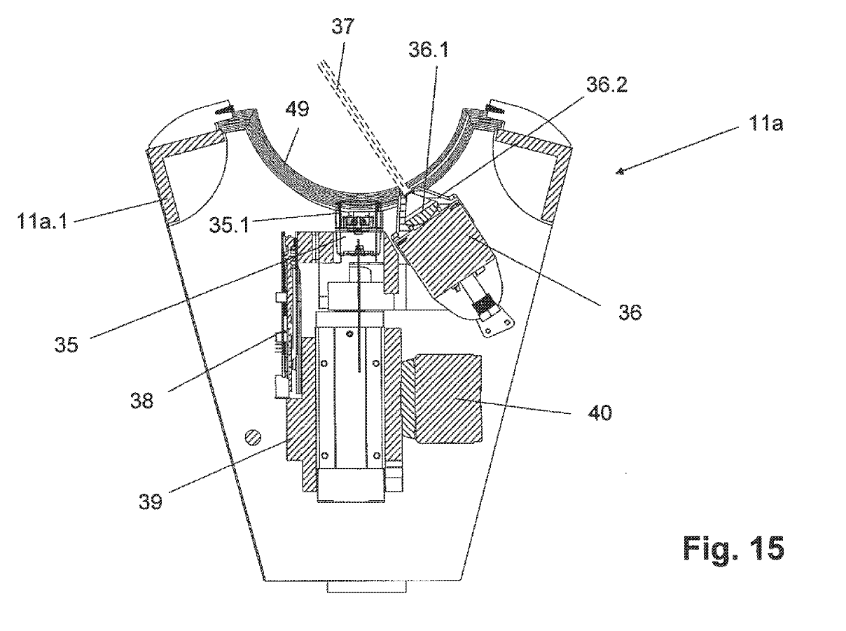

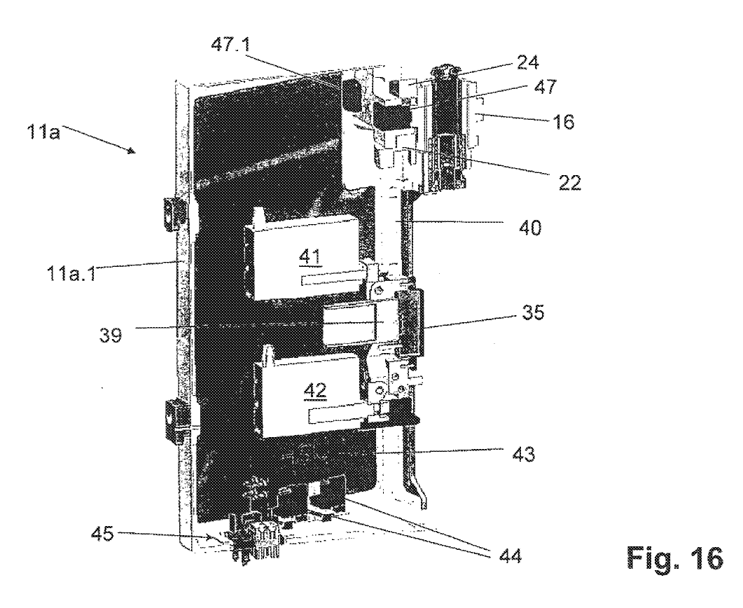

The printing segments 11 are disposed adjacent to one another along the periphery of the rotor 12. In plan view, as shown in FIG. 15, these printing segments 11 are configured like wedges.

The printing segments 11 enclose a space in the region of the machine axis MA. As shown in FIG. 12, this space accommodates functional elements for triggering printing segments 11. Such functional elements include electronic control elements or computers 14.

Each printing segment 11 has a side that is radially outward relative to the machine axis MA. As shown in FIGS. 4 and 5, this radially outward side forms a recess 15. During handling, each recess 15 receives a package 2 at least by a part of its package body. At the time the recess receives the package 2, a holding-and-centering unit 16 suspends the package 2 from a region around the package's top or opening. As a result, the package 2 is oriented vertically and parallel to machine axis MA and to a printing-segment axis DA. In the region at which the package 2 is mounted, and in particular, in the region of the recess 15, each printing segment 11 includes both at least one print head and any other functional elements required to print on the package 2.

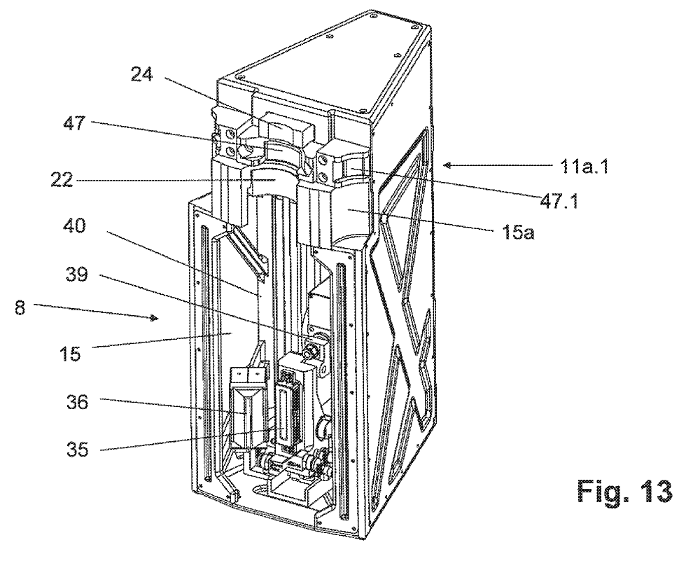

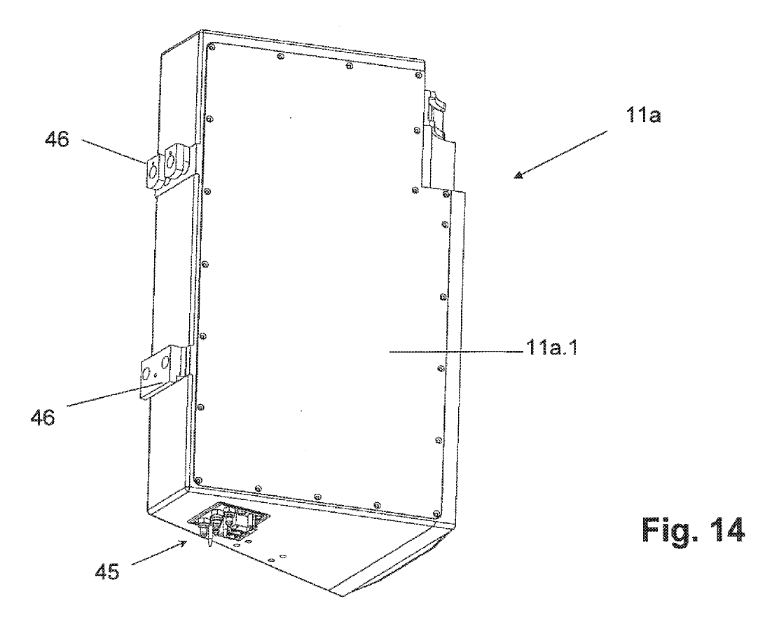

Referring to FIG. 5, each carrier 17 holds a holding-and-centering unit 16. The carrier 17 is fastened in associated lateral slots 18. In some embodiments, a motor moves the carrier 17 along its associated lateral slots 18 like a carriage In an alternative embodiment, depicted in FIG. 13, the carrier 17 is not configured in that form. In this embodiment, all elements or functions are directly integrated into the printing segment 11, 11a.

During package handling and/or printing, a holding-and-centering unit 16 causes alignment, controlled rotation, and/or pivoting of the package 2 about a vertical packaging-element axis thereof. This packaging-element axis is disposed along the same axis as the printing-segment axis DA.

Each holding-and-centering unit 16 includes a primary part 19 and a secondary part 20. The holding-and-centering unit's corresponding carrier 17 holds the primary part 19. The secondary part 20 is below the primary part 19.

The primary part 19 secures and aligns the holding-and-centering unit 16 on its carrier 17, on a holder 8, or on a printing segment 11. For this purpose, the primary part 19 includes a reference face 19.1 whose complementary counterpart in the printing segment 11 serves as a reference plane or reference face for locating and hence for adjustment relative to the print head. This creates a fixed common reference between the holding-and-centering unit 16 or packages 2 and its corresponding print head or print heads.

The secondary part 20 includes a gripper that suspends the package 2. Embodiments include a mechanical gripper, a pneumatically actuated gripper, and/or a vacuum gripper. Preferably, while in the printing segment 11, the required holding force is passively applied to the primary part 19 and actively removed or released, for example by way of one or more permanent magnets, so as to increase safety in the absence of flow or media.

The secondary part 20 includes the active components. These active components include mechanical elements and pneumatic elements. The mechanical elements are needed for aligning, controlled rotating and/or pivoting the package 2 during handling. The pneumatic elements supply compressed air and/or provide exposure to a vacuum.

The secondary part 20 is mounted on the primary part 19 so as to be able to rotate or pivot about the printing-segment axis DA. In the illustrated embodiment, the secondary part 20 includes the rotor of an electric positioning or angular drive for the aligning and controlled rotating or pivoting of a package 2 during handling.

The secondary part 20 also includes a permanent-magnet array 21 that has a permanent magnets. In a peripheral direction, the permanent-magnet array 21 has alternating north and south poles. The permanent-magnet array 21 interacts with a solenoid array 22 on the carrier 17. The solenoid array 22 forms the stator of a positioning drive or of an electromagnetic direct drive.

As shown in FIG. 5, the primary part 19 includes a code 23 that interacts with an incremental sensor 24 provided on the carrier 17. The incremental sensor 24 uses the code 23 to determine the random orientation of the primary part 19, and hence an orientation of the holding-and-centering unit 16. After having been determined by the encoder system, this orientation can then be taken into account when aligning and carrying out controlled rotating of the packages 2 during printing.

Package handling occurs solely by rotating the secondary part 20. The primary part 19 need not rotate. The incremental sensor 24 rotates with the rotor 12 or pillar 13. The alignment and controlled rotation of the package 2 about the printing-segment axis DA is effected relative to the printing segment 11 or relative to functional elements located at the printing segment 11, such as print heads.

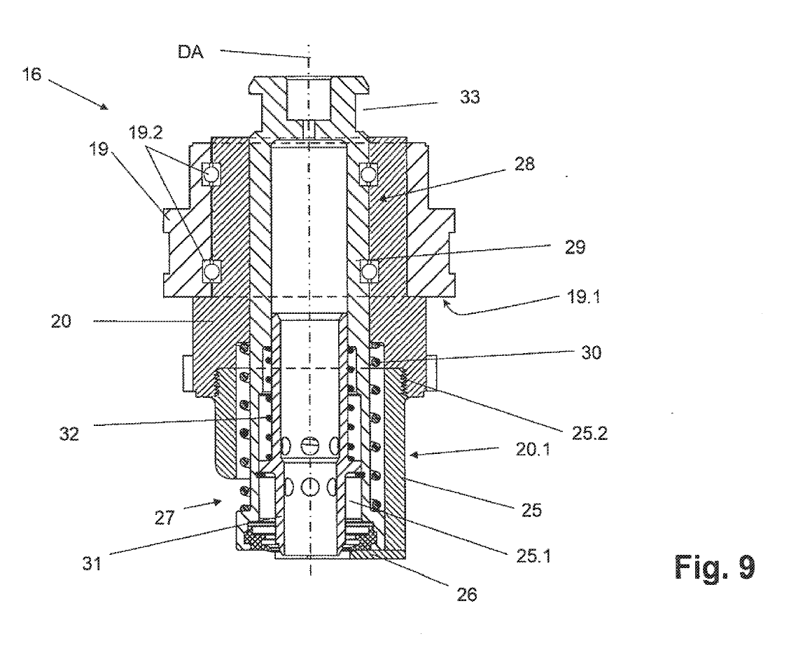

FIG. 9 shows a sectional view of the holding-and-centering unit 16 in an idle position. In this idle position, the holding-and-centering unit 16 does not carry a package 2.

The holding-and-centering unit 16 has a ring-like primary part 19 and a sleeve-like secondary part 20 that is mounted in the primary part 19 so as to be able to rotate about the printing-segment axis DA. A lower length of the secondary part 20 projects beyond the underside of the primary part 19. This lower length of the secondary part 20 is configured with a mounting-and-base part 20.1.

FIG. 9 shows bearings 19.2 that permit the secondary part 20 to rotate relative to the primary part 19. These can include a bearing sleeve, needle bearing, or an equivalent structure.

The mounting-and-base part 20.1 is adapted to the type, shape, and size of the packages 2. It forms part of a gripper for holding an empty package 2.

Specifically, the mounting-and-base part 20.1 has a sleeve 25 and a carrier plate 26. The sleeve 25 is arranged with its axis on the same axis as the printing-segment axis DA. The carrier plate 26 is at the lower open end of the sleeve 25.

A thread 25.2 permits the mounting-and-base part 20.1 to be separated from the upper section of the sleeve 25. Instead of a thread 25.2, it is possible to use a bayonet closure, clamp or other mechanism.

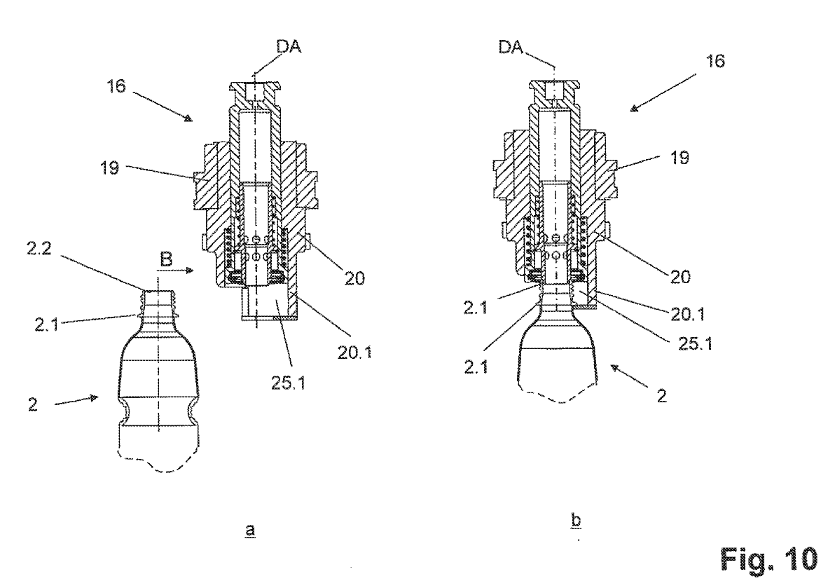

A lateral opening 27 in the sleeve 25 permits a package to be introduced into the mounting-and-base part 20.1. This procedure is shown in FIG. 10 for the case of a package 2 embodied as a bottle.

Position (a) of FIG. 10 shows a package 2 being moved along an introducing direction B towards the lateral opening 27 formed in the mounting-and-base part 20.1. Position b of FIG. 10 shows the package 2 fixed to the mounting-and-base part 20.1 in such a way that the carrier plate 26 suspends the package 2 by its mouth edge 2.1.

Referring back to FIG. 9, within the secondary part 20, a centering-and-holding element 28 is arranged to be axially displaceable relative to the printing-segment axis DA. The centering-and-holding element 28 includes an outer sleeve-body 29. A first compression spring 30 preloads the outer sleeve-body 29 into a lower position.

The sleeve body 29 lies with its lower end face against the carrier plate 26. When the package 2 is a bottle held at a holding-and-centering unit 16, the sleeve body 29 lies against the upper side of the package 2, which faces away from the carrier plate 26 or against the mouth edge 2.2 of the package 2 located there. The force of the first compression spring 30 between the sleeve body 29 and the carrier plate 26 firmly clamps the package 2 so that it cannot rotate.

The centering-and-holding element 28 also includes centering sleeve 31 arranged on the same axis as the 3 printing-segment axis DA. This centering sleeve 31 is axially displaceable. A second compression spring 32 preloads the centering sleeve 31 into a lower position. As can be seen in FIG. 9, the first and second compression springs 31, 32 are concentric.

In order to receive a package 2, a lifting element engages behind a collar or annular slot 33 of the sleeve body 29. Such a lifting element is provided at the package inlet 1.1 and the package outlet 1.2. The lifting element raises the centering-and-holding element 28 against the action of the first compression spring 30.

After the package 2 has been introduced into the holding-and-centering unit 16, the first and second compression springs 30, 32 urge the centering-and-holding element 28 downward, thereby centering and positioning the package 2 in the mounting-and-base part 20.1 and passively clamping it.

In the process, the centering sleeve 31 centers the package 2 in such a way that the package axis is coaxial with the printing-segment axis DA. The packages 2, which can be bottles, can then be printed upon while they are empty.

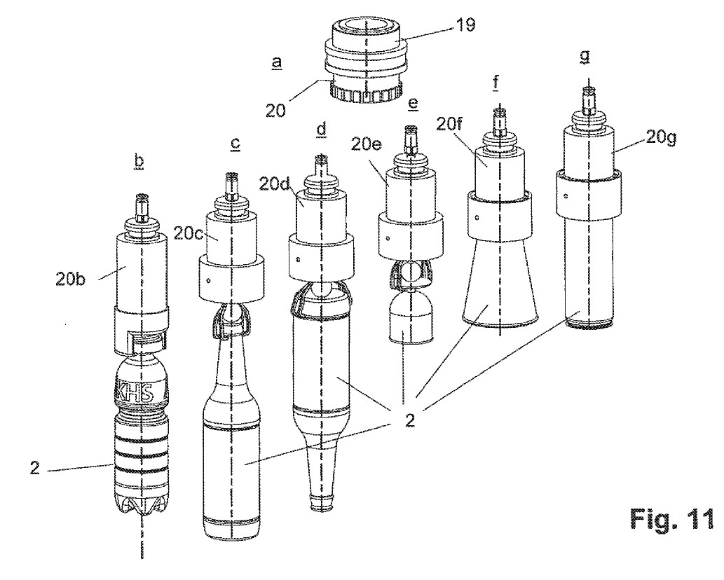

The concentrically arranged first and second compression springs 30, 32 and the guides and supports that can be pushed into one another are coupled to apply a weaker force during centering and a stronger force during clamping. Thus, when the package 2 is being centered, a weak spring force acts on the container mouth so that a slight movement of the package 2 on the carrier plate 26 can still take place. Once the package 2 is centered, a final holding force achieves a gas-tight condition, as shown in FIG. 11.

FIGS. 10 and 11 in turn show an alternative embodiment in which the mounting-and-base part 20.1 is not detachable or is made of a single piece.

The illustrated embodiment shows the use of springs to achieve the required forces. However, other equivalent drives are conceivable for the clamping of the packages. These equivalent drives include, for example, pneumatically or electrically driven gripping and/or clamping elements.

Packages 2 are picked up in a protected manner by their mouth region between mouth flange 2.1 and mouth edge 2.2 in the interior 25.1 of the sleeve 25. In particular, with a very hygienic variant, it is an advantage to configure holding-and-centering units 16 or their secondary parts 20 in such a way that the mouth 2.2 or a package 2, and nearby structures such as the mouth region and a thread located in the mouth regions, are all protected from dirt and ink spray during the printing operation.

In order to stabilize the still-empty packages 2, it is expedient to fill them with a pressure medium, such as a pressurized gaseous and/or vaporous medium, for example with compressed air. This filling occurs during or after a packages 2 has been fixed to its holding-and-centering units 16.

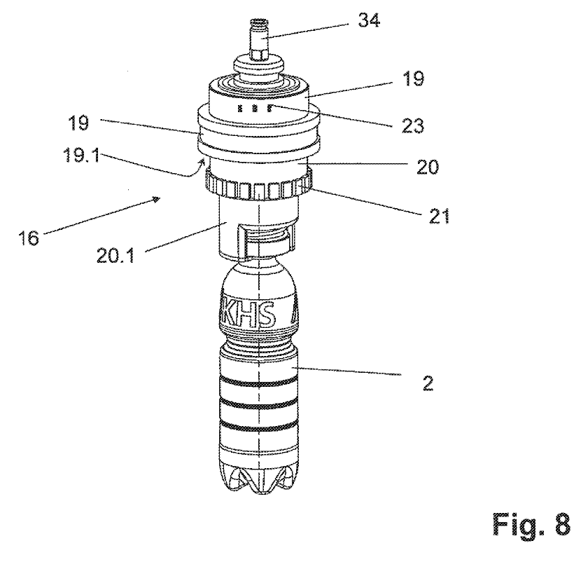

As shown in FIG. 8, a quick-acting coupling 34 connects to a source of pressurized medium at the holding-and-centering unit 16 or at its centering-and-holding element 28. The internal pressure in the package 2 can continue to be controlled by this quick-acting coupling 34, by a line (also not shown) in the interior of the holding-and-centering unit 16 and by a gas outlet. Ideally the internal pressure is held constant over the entire transport path. As can be seen from FIG. 9, the holding-and-centering unit 16 has a central inner cavity through which the pressurized medium can pass into package's interior.

Packages come in different package formats. A format refers to the type, size, and/or shape of a package. A container-processing machine is expected to be able to process packages with different formats.

The secondary part 20 is preferentially configured in such a way that a format-dependent mounting-and-base part 20.1 can be attached to and detached from the secondary part 20. This makes it easier to reconfigure the secondary part 20 for processing packages 2 having different package formats.

When reconfiguring the machine to accommodate a new package format, it becomes possible to simply exchange the mounting-and-base parts 20.1 on the holding-and-centering units 16 with a suitably matching format-dependent mounting-and-base part 20.1. The format-dependent mounting-and-base part 20.1 is preferably mounted to the secondary part 20 in a torsion-proof manner, for example with the help of a quick-change mechanism, a quick-acting coupling, a screw fastener, and/or a clamp-fastener.

FIG. 11 again shows, in position (a), a primary part 19 of a holding-and-centering unit 16 in single view, and in positions (b)-(g), first through sixth different secondary parts 20b-20g for different packages 2. These secondary parts are formed at least in part by different mounting-and-base parts 20.1. In the case of the depicted embodiments, the first, second, third, and fourth secondary parts 20b-20e are mechanical grippers that are actuated by, for example by compressed air. The fifth and sixth secondary parts 20f, 20g are vacuum grippers.

The first, second, and fourth secondary parts 2b, 2c, 2e hold their respective packages either at the top of the package or in the region of the package's opening. The fourth secondary part 2d, in contrast, holds the package by its underside. The fifth and sixth secondary parts 20f, 20g both hold a package from its top.

Some embodiments include a unique identifier for each holding-and-centering units 16, and preferably each secondary part 20. A suitable identifier is an RFID code that identifies the holding-and-centering unit 16. The RFID code can include information about the unit's type and/or information about its particular secondary part 20. The corresponding information can then be read out by at least one reading unit of the device 1 and/or of respective print module 4.1-4.n, for example for monitoring or inspection purposes.

FIG. 12 depicts a transport-and-treatment element 7b that can be used in the device 1 instead of transport-and-treatment elements 7. The transport-and-treatment element 7b differs from transport-and-treatment elements 7 essentially in that the printing segments 11a that form transport-and-treatment elements 7b do not have the height-adjustable or displaceable carrier 17. Instead, each holding-and-centering unit 16 is held directly, i.e. not height adjustably, on its printing segment 11a. Accordingly, incremental sensor 24 and solenoid array 22 are also provided on the printing segment 11a or on its housing 11a.1.

Printing segments 11a are again provided adjacent to one another on the rotor 12, which in turn is mounted on the pillar 13 of the base unit 5a that corresponds to the base unit 5 so as to be rotatable and drivable about the vertical machine axis MA.

In the interior of its segmented housing 11a.1, each printing segment 11a has the functional segments needed for printing packages 2. These include, for example, at least one inkjet print head 35 having electronically controllable discharge jets for printing color or printing ink and other media. The print heads 35 are arranged in at least one row parallel to the printing-segment axis DA.

A drying device 36 for the immediate drying of the printing color or corresponding printed image applied to package 2 is associated with each print head 35. In the depicted embodiment, the drying device 36 is an infrared and/or UV emitter discharging a linear field of UV and/or infrared radiation 37 that covers at least the entire printed image applied with print head 35. The drying device 36 is offset by some angle against print head 35 relative to the printing-segment axis DA.

During printing of a package 2, the print head is subjected to a controlled rotation about the printing-segment axis DA in such a way that the printing color applied with the print head 35 is dried or at least largely dried with the UV and/or infrared radiation 37 immediately following application.

In a way not otherwise represented, drying device 36 is cooled, for example using air and/or water as the cooling medium.

The print head 35, the drying device 36, as well as electronics 38 configured at least as a driver stage for the print head 35, are all provided on a common carriage 39 that is adjustably guided in the direction of the printing-segment axis DA on a pillar 40 by way of a positioning drive 41. In the depicted embodiment, by way of a positioning or angular drive 42 that is provided on carriage 39, the print head 35 and the dry ng device 36 can again be adjusted by pivoting, preferably by pivoting about at least one axis that is square to the printing-segment axis DA and tangential to the periphery of transport-and-treatment element 7b as formed by the printing segments 11a. As a result, the position of the print head 35 can be matched to the position of the packaging element surface that is to be printed upon such that the jet openings of the print head 35 are as close as possible to the package's surface and so that the center-lines of the jet openings are as square as possible relative to the package surface that is to be printed upon.

To avoid fouling the printing segment 11a with sprayed ink, the print head 35 is configured with a protective element 35.1. The protective element 35.1 can be blade-like, scale-like and/or rubber-ball-like. During printing, the protective element 35.1 lies against the package 2 being printed upon to outwardly limit the printed space.

To configure the bundled linear infrared beam 37, the drying device 36 is executed with an optical beam forming element 36.1 in the form of a cylindrical lens and with a protective and guiding aperture 36.2.

Accommodated in the interior of housing 11a.1 are other functional elements of the printing segment 11. These include a pressure-balancing tank 43 for the colored-ink, pumps 44 for feeding ink and for removing surplus ink, as well as other functional elements that are not depicted, such as electronic control elements for the controlling of the respective printing segment 11 and the controlling of drives 41 and 42 etc. The underside of the housing 11a.1 is provided with a coupling unit 45 by which all necessary electrical connections (in particular also for drives and controlling and monitoring data) and all fluid connections (for cooling functional elements and for feeding ink) can be made by plugging into a matching coupling unit (coupling panel) provided on the rotor 12.

On the narrow rear side, which lies radially inward relative to machine axis MA, mechanical holding-and-centering elements 46 are provided on the housing 11a.1 of each printing segment 11a. With these holding-and-centering elements 46, a secure and exact connecting of the print module 11a with the rotor 12 or with a rotor element concentrically surrounding machine axis MA is at least partially possible by plugging in the printing segment 11a.

An aperture-like wall 49 is provided on the inside of the recess or mounting 15. The aperture-like wall 49 closes off the interior space of housing 11 except for openings for the carrier 17, the print head 35 and UV and/or infrared drying unit 36.

It has been assumed above that the holding-and-centering units 16 are part of individual modules 4.1-4.n or printing segments 11, 11a. In a preferred embodiment however, the holding-and-centering units 16 are pucks. Each puck picks up a package 2 at the package inlet 1.1 and only releases that package 2 again at the package outlet 1.2. This means that each package 2 is held constantly on one and the same holding-and-centering unit 16 on the transport path 3 between package inlet 1.1 and the package outlet 1.2.

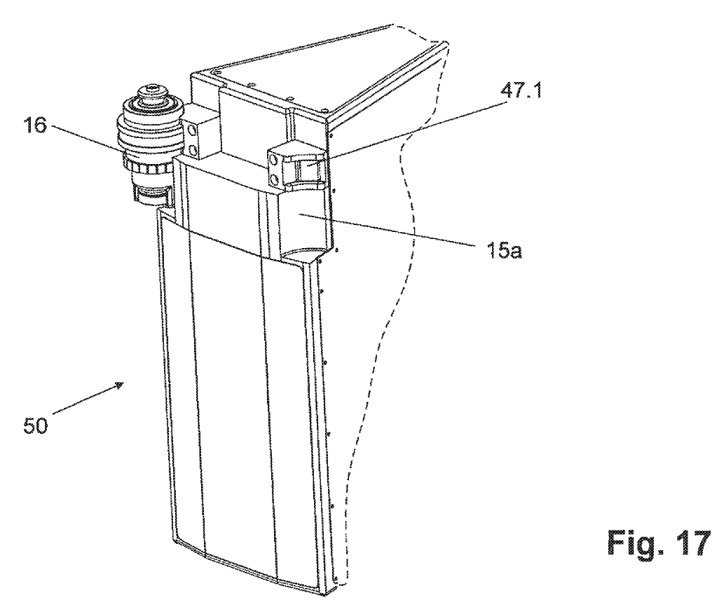

In the course of traversing the transport path 3, the holding-and-centering unit 16 is passed on from a transport-and-treatment element 7, 7a, 7b or from a mounting 15 located there to a transport-and-treatment element 7, 7a, 7b following in transport direction A or to a mounting 15 located there. Mechanisms for holding and releasing the holding-and-centering units 16 are provided on the carriers 17 of the printing segments 11 or on the printing segments 11a for this purpose. FIG. 17 shows one example in the form of a radially projecting holding ring that interacts with or is held by controlled solenoids 47. Other gripper-like mounting, holding and/or transfer elements can also be used.

From the package outlet 1.2, the holding-and-centering units 16 are returned on a puck transport path to the package inlet 1.1. This puck transport path, which is schematically and/or functionally suggested in FIG. 1 by the broken line 48, is constituted by autonomous transport-and-treatment elements or by transport-and-treatment elements 7. In the latter case, an additional mounting 15a is then provided between two recesses 15 for the mounting of a holding-and-centering unit 16 (FIGS. 4 and 12). In the case of the depicted embodiments, this is formed by corresponding concave vaults in the face of each of two printing segments, such as printing segments 11, 11a or their respective housings 11.1, 11a.1. These additional recesses 15a for the empty holding-and-centering units 16 that are to be returned are thus each formed from two part-recesses and are, in the depicted example, on the same level as the receptacles 15. Additional recesses 15a also exhibit holding magnets and solenoids 47.1, with a holding magnet and solenoid 47.1, also executed as a permanent magnet if necessary, being provided at least in every second, and ideally in both part-receptacles.

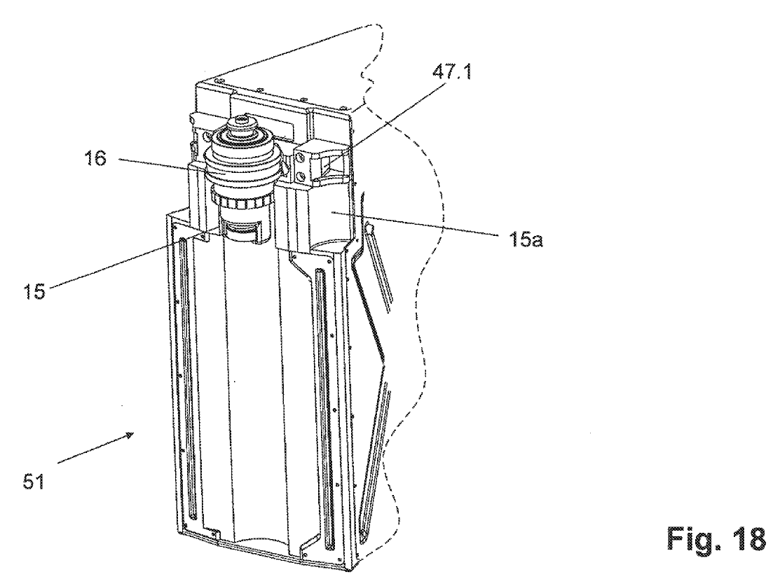

FIGS. 17 and 18 show two different dummy segments 50, 51 that match, or that have housings that match the shape, size, or dimension of the printing segments 11a and that essentially differs from the printing segments 11a only because they do not exhibit all of the functional elements needed for the printing of packages 2.

The dummy segments 50, 51 are arranged on transport-and-treatment elements 7b between printing segments 11a in order to reduce the number of handling positions 8 formed by printing segments 11a on transport-and-treatment elements 7b if, for example, only a reduced throughput (number of packages 2 handled per unit of time) is required for the corresponding device 1. The dummy segments 50, 51 can also be used to return holding-and-centering units 16, which are configured as pucks, from the package outlet 1.2 to the package inlet 1.1, with holding-and-centering units 16 being held either at the receptacles 15 or at regions of the dummy segments 50, 51 that correspond to receptacles 15a.

FIG. 12 shows an annular tank 42 surrounding the pillar 13. The annular tank 42 receives ink of the respective printing color. It is provided, for example, on the base unit 5a and is connected by a rotary connection with pressure balancing tanks 43 and/or with pumps 44 located at the pressure balancing tanks 43.

Among the advantages are that the relationship of packages 2 to the basic machine or device 1 is decoupled, i.e. in particular holding-and-centering units 16, which are configured as pucks, can be adapted to different shapes, sizes, etc. of packages 2 and that a height adjustment of carriers 17 and/or of carriages 39 carrying print heads 35 is also possible for adapting to the different shapes, sizes, and forms of packages 2.

Another advantage of the invention is that printing segments 11, 11a are configured as fully functional assembly units or modules. This means that not only is the assembly of the respective device 1 simplified, but it is also possible to replace, for example, faulty printing segments 11, 11a and to repair such printing segments 11, 11a outside the device 1.

Yet another advantage is simplification of stock-keeping by the manufacturer of the device 1.

Yet another advantage is that the use of dummy segments 50, 51 makes it possible to adapt device 1 to a reduced throughput.

Another advantage is that structurally identical base units 5 can be used with structurally identical printing segments 11 to realize the device 1. This generally results in a compact design for the device 1.

The invention has been described by reference to particular embodiments. However, numerous, variations as well as modifications are possible, in particular including to holding-and-centering units 16, printing segments 11, 11a and the device as a whole, without departing from the inventive concept underlying the invention.

For example, instead of the code 23 being on the primary part 19, the code 23 can be provided on the secondary part 20, or on both to then together constitute, with an incremental sensor disposed on the printing segment 11, 11a, an encoder system for the aligning and/or controlled rotating of packages 2.

The invention has also been described in the context of packages 2 that are bottles. The inventive device, its holding-and-centering units, and its printing segments are however also suited to the applying a furnishing onto other containers or packages.

Having described the invention, and a preferred embodiment thereof, what is claimed as new and secured by. Letters Patent is:

1. (canceled)

2. An apparatus comprising a plurality of pucks, a functional element, and a plurality of holding positions, wherein said plurality of pucks comprises a first puck, wherein said plurality of holding positions comprises a first holding-position, wherein said first puck comprises a primary part and a secondary part, wherein said secondary part is reconfigurable, wherein, as a result of being reconfigurable, said secondary part is adaptable for processing packages that have different package-formats, wherein, when said first puck holds a package, said first holding-position holds said primary part, wherein said secondary part is mounted to be in contact with said primary part so as to rotate about a vertical axis of said first puck when driven, wherein said secondary part receives said functional element, and wherein said functional element is configured for at least one of holding, centering, aligning, moving, rotating, and pivoting said package while said first holding-position holds said primary part.

3. The apparatus of claim 1, wherein each holding position comprises an inkjet print-head and a radiation source.

4. The apparatus of claim 1, further comprising a servomotor and a mounting-and-base part, wherein said primary part houses said servomotor, wherein said secondary part comprises a gripper that comprises said mounting-and-base part, and wherein said secondary part is made configurable as a result of said mounting-and-base part.

5. The apparatus of claim 1, further comprising an electromagnetic direct drive configured to cause controlled handling of a package.

6. The apparatus of claim 1, further comprising a plurality of transport-and-treatment modules that define a transport path along which said first puck carries a package between an inlet and an outlet, wherein each of said transport-and-treatment modules has a vertical machine-axis, wherein each holding position comprises a holder that engages a puck, wherein each of said holders is adjustable in a direction along a machine axis of a transport-and-treatment module at which said holder is located.

7. The apparatus of claim 1, wherein a lower length of said secondary part projects beyond an underside of said primary part.

8. The apparatus of claim 1, wherein each secondary part comprises a centering-and-holding element that is configured for passively holding a package with a spring force.

9. The apparatus of claim 1, wherein each puck comprises a recess configured to cover said package in a region of a mouth thereof.

10. The apparatus of claim 1, wherein each of said holding positions comprises a receptacle to receive said first puck as said first puck traverse a puck transport-path that passes through multiple transport-and-treatment elements and that extends between a package inlet and a package outlet.

11. The apparatus of claim 1, further comprising a package transport-path on which packages are moved from a package inlet to a package outlet in a transport direction, wherein said holding positions are disposed along said package transport path, wherein each of said holding positions is configured to hold a puck, and wherein said holding positions are on a module that is driven to rotate about a vertical machine axis thereof.

12. The apparatus of claim 1, further comprising, at each holding position, a mechanism for controlled holding and releasing of pucks.

13. The apparatus of claim 1, wherein said secondary part comprises a sleeve and a carrier plate, wherein said carrier plate is disposed at a lower open end of said sleeve.

14. The apparatus of claim 1, wherein each holding position comprises an inkjet print-head that is adjustable along a machine axis.

15. The apparatus of claim 1, wherein said puck comprises a ring and a sleeve, wherein said sleeve is mounted to said ring to rotate relative to said ring.

16. apparatus of claim 1, wherein each puck comprises a recess configured to cover said package in a region of a mouth thereof.

17. The apparatus of claim 1, wherein said secondary part comprises an RFID tag.

18. The apparatus of claim 1, wherein said first puck picks up a package at a package inlet and moves, with said package, from said package inlet to a package outlet along a package transport path, wherein, upon arriving at said package outlet, said first puck releases said package, and wherein said apparatus further comprises a puck transport path over which said first puck is returned from said package outlet back to said package inlet.

19. The apparatus of claim 1, wherein each holding position comprises an inkjet print head that is adjustable along a line having an inclination relative to a machine axis.

20. The apparatus of claim 1, further comprising a non-return valve and a transport-and-treatment element having a coupling element that connects to a pressure medium, wherein said first puck comprises said non-return valve, and wherein said non-return valve couples via said coupling element to said source.

21. The apparatus of claim 1, further comprising an array of permanent magnets and a structure selected from the group consisting of a solenoid array and a stator, wherein said structure interacts with said array of permanent magnets for at least one of controlled alignment and controlled rotation of a package.

22. The apparatus of claim 1, further comprising a first mounting-and-base part, wherein said secondary part is reconfigured by interchanging said first mounting-and-base part with a second mounting-and-base part, and wherein said first and second mounting-and-base parts are adapted to a different package-formats.

23. The apparatus of claim 1, further comprising a printing segment, wherein said first puck is held at said printing segment by passive application of a holding force to said primary part, and wherein, after a package held by said first puck has been printed upon, said first puck is actively removed from said printing segment.

24. The apparatus of claim 1, further comprising a plurality of transport-and-treatment elements adjacent to one another for transporting packages, wherein each of said transport-and-treatment elements comprises a vertical axis about which at least some of said holding positions rotate, wherein said transport-and-treatment elements define a package transport path that extends between a package inlet and a package outlet, and wherein said first holding position is one of a plurality of holding positions along a first one of said transport-and-treatment elements.

25. The apparatus of claim 1, further comprising a plurality of transport-and-treatment elements adjacent to each other to define a path along which said first puck moves from an inlet to an outlet, wherein said transport-and-treatment elements comprise a first transport-and-treatment element, wherein said first transport-and-treatment element is connectable to a pressure medium, wherein said first transport-and-treatment element comprises a coupling element, and wherein said first puck comprises a quick-acting coupling for coupling to a source of said pressure medium.

26. The apparatus of claim 1, further comprising a sensor configured to detect a rotation angle based on a structure on said primary part, wherein said structure is configured to define a rotational angle of said primary part relative to a holding position.
